(19) United States
(12) Patent Application Publication
(10) Pub. No.: US 2019/0017583 A1
(43) Pub. Date: Jan. 17, 2019

(54) FOUR MODE DUAL PLANETARY POWERTRAIN CONFIGURATIONS WITH A BALL VARIATOR CONTINUOUSLY VARIABLE TRANSMISSION USED AS A POWERSPLIT

(71) Applicant: DANA LIMITED, MAUMEE, OH (US)

(72) Inventors: THIBAULT G. DEVREESE, GENT (BE); SEBASTIAN J. PETERS, CEDAR PARK, TX (US)

(73) Assignee: DANA LIMITED, MAUMEE, OH (US)

(21) Appl. No.: 16/069,538

(22) PCT Filed: Jan. 13, 2017
(86) PCT No.: PCT/US2017/013332

§ 371 Date: Jul. 12, 2018

Related U.S. Application Data
(60) Provisional application No. 62/278,032, filed on Jan. 13, 2016.

(51) Int. Cl. F16H 37/08; F16H 15/50

(52) U.S. Cl. CPC F16H 37/086; F16H 2037/0873; F16H 15/503

(57) ABSTRACT

Devices and methods are provided herein for the transmission of power in motor vehicles. Power can be transmitted in a smoother and more efficient manner by splitting torque into two or more torque paths. A continuously variable transmission is provided with a ball variator assembly, a planetary gear set coupled thereto and an arrangement of rotatable shafts with multiple gears and clutches that extend the ratio range of the variator. In some embodiments, clutches are coupled to the gear sets to enable synchronous shifting of gear modes. In some embodiments, clutches are coupled to chain drives to enable synchronous shifting of gear modes.

### RELATED APPLICATION

This application claims the benefit of U.S. Provisional Application No. 62/278,032 filed on Jan. 13, 2016, which is herein incorporated by reference.

### BACKGROUND

A driveline including a continuously variable transmission allows an operator or a control system to vary a drive ratio in a stepless manner, permitting a power source to operate at its most advantageous rotational speed.

### SUMMARY

Provided herein is a continuously variable transmission (CVT) including a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a fourth rotatable shaft aligned substantially coaxial to the third rotatable shaft; and a variator assembly having a first traction ring assembly and a second traction ring assembly in contact with a plurality of traction planets, each traction planet having a tiltable axis of rotation. The variator assembly is coaxial with the main axis, the second traction ring assembly is coupled to the second rotatable shaft. Additionally, the CVT includes a first planetary gear set having a first sun gear, a first planet gear array, and a first ring gear, wherein the first sun gear is coupled to the second traction ring, the first ring gear is coupled to the first traction ring, and the first planet gear array is operably coupled to the first rotatable shaft; a second planetary gear set operably coupled to the third rotatable shaft, the second planetary gear set having a second sun gear, a second planet gear array, and a second ring gear, wherein the second ring gear is coupled to the fourth rotatable shaft; a first clutch positioned coaxial with the third rotatable shaft, the first clutch operably coupled to the second ring gear and the second sun gear; a second clutch coupled to the third rotatable shaft; a third clutch coaxial with the fourth rotatable shaft, the third clutch operably coupled to the first ring gear; and a fourth clutch coaxial with the fourth rotatable shaft, the fourth clutch operably coupled to the second rotatable shaft.

Provided herein is a vehicle driveline including a power source, a continuously variable transmission of any configuration described herein or that would be obvious to one of skill in the art having read the disclosure herein drivingly engaged with the power source and a vehicle output drivingly engaged with the continuously variable transmission.

Provided herein is a method including providing a vehicle including a continuously variable transmission of any configuration described herein or that would be obvious to one of skill in the art having read the disclosure herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a side sectional view of a ball-type variator.

FIG. 2 is a plan view of a carrier member that can be used in the variator of FIG. 1.

FIG. 3 is an illustrative view of different tilt positions of the ball-type variator of FIG. 1.

FIG. 4 is a schematic diagram of a four-mode dual planetary powersplit continuously variable transmission.

FIG. 5 is a schematic diagram of another four-mode dual planetary powersplit continuously variable transmission.

FIG. 6 is a schematic diagram of yet another four-mode dual planetary powersplit continuously variable transmission.

FIG. 7 is a table depicting operating modes of any one of the continuously variable transmissions depicted in FIGS. 4-6.

### DETAILED DESCRIPTION OF THE DRAWINGS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the embodiments can include several novel features, no single one of which is solely responsible for its desirable attributes or which is essential to practicing the embodiments described.

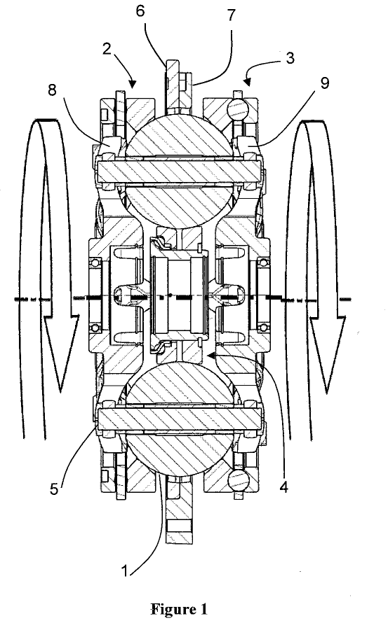

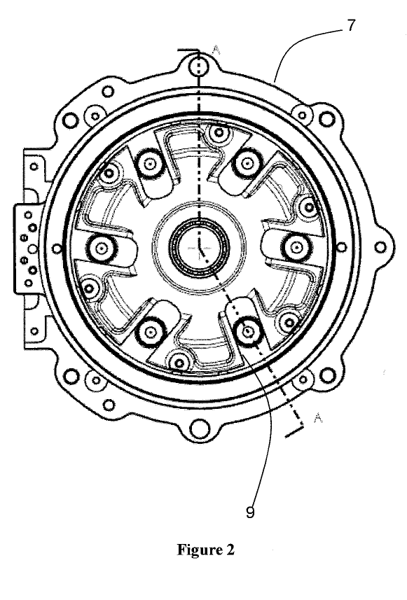

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 can rotate with respect to the second carrier member 7, and vice versa. In some embodiments, the first carrier member 6 can be substantially fixed from rotation while the second carrier member 7 is configured to rotate with respect to the first carrier member, and vice versa. In one embodiment, the first carrier member 6 can be provided with a number of radial guide slots 8. The second carrier member 7 can be provided with a number of radially offset guide slots 9, as illustrated in FIG. 2. The radial guide slots 8 and the radially offset guide slots 9 are adapted to guide the tiltable axles 5. The axles 5 can be adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

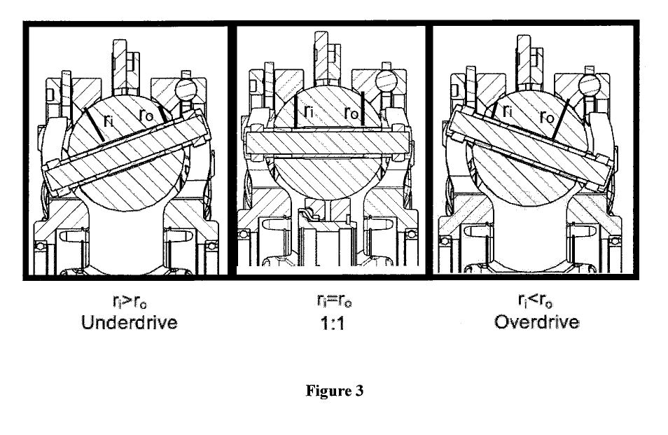

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio can be changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling can take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (p) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here can operate in both tractive and frictional applications. For example, in the embodiment where a CVT is used for a bicycle application, the CVT can operate at times as a friction drive and at other times as a traction drive, depending on the torque and speed conditions present during operation.

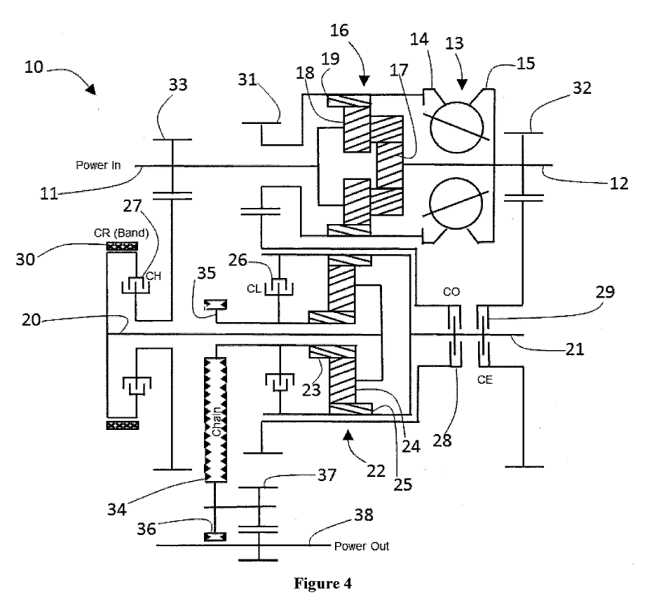

Referring now to FIG. 4, in one embodiment, a continuously variable transmission (CVT) 10 is provided with a first rotatable shaft 11 coaxial with a second rotatable shaft 12. The first rotatable shaft 11 and the second rotatable shaft 12 form a main axis of the CVT 10. The first rotatable shaft 11 is operably coupleable to a source of rotational power. The CVT 10 includes a variator 13 having a first traction ring assembly 14 and a second traction ring assembly 15. For purposes of description and not limitation, the variator 13 is substantially similar to the type of variator depicted in FIGS. 1-3. The variator 13 is coaxial with the main axis of the CVT 10. The CVT 10 has a first planetary gear set 16 coaxial with the main axis. The second traction ring assembly 15 is coupled to the second rotatable shaft 12. The first planetary gear set 16 includes a first sun gear 17, a first planet gear array 18, and a first ring gear 19. In some embodiments, the first planet gear array 18 is configured with well-known stepped gears adapted to couple the first sun gear 17 to the first ring gear 19.

The CVT 10 has a third rotatable shaft 20 arranged substantially parallel to the main axis. The CVT 10 has a fourth rotatable shaft 21 arranged coaxial with to the third rotatable shaft 20. A second planetary gear set 22 is coupled to the third rotatable shaft 20. The second planetary gear set 22 includes a second sun gear 23, a second planet gear array 24, and a second ring gear 25. The CVT 10 is provided with a first clutch 26 arranged coaxially with the third rotatable shaft 20. The first clutch 26 is configured to selectively couple the second ring gear 25 and the second sun gear 23. The CVT 10 is provided with a second clutch 27 arranged coaxially with the third rotatable shaft 20. The CVT 10 is provided with a third clutch 28 and a fourth clutch 29, each arranged coaxially with the fourth rotatable shaft 21.

The CVT 10 includes a reverse band 30 coupled to the second clutch 27. In one embodiment, the reverse band 30 is configured to selectively engage a reverse mode of operation. In one embodiment, the reverse band 30 is a steel band configured to wrap around the second clutch 27. Typically, bands used in transmissions are actuated by hydraulic cylinders inside the case of the transmission.

The CVT 10 is provided with a first gear set 31 adapted to couple the first ring gear 19 to the third clutch 28. The CVT 10 is provided with a second gear set 32 adapted to couple the second rotatable shaft 12 to the fourth clutch 29. The CVT 10 is provided with a third gear set 33 adapted to couple the first rotatable shaft 11 to the second clutch 27.

The CVT 10 is provided with a chain drive 34. The chain drive 34 includes a first sprocket 35 and a second sprocket 36. For descriptive purposes, reference to a chain drive includes typical sprockets and coupling hardware intended for transmission of rotational power. The first sprocket 35 is coupled to the first clutch 26. The second sprocket 36 is coupled to a final gear set 37. The final gear set 37 is operably coupled to a final draft shaft 38. In some embodiments, the final draft shaft 38 is coupled to drive wheels of a vehicle (not shown).

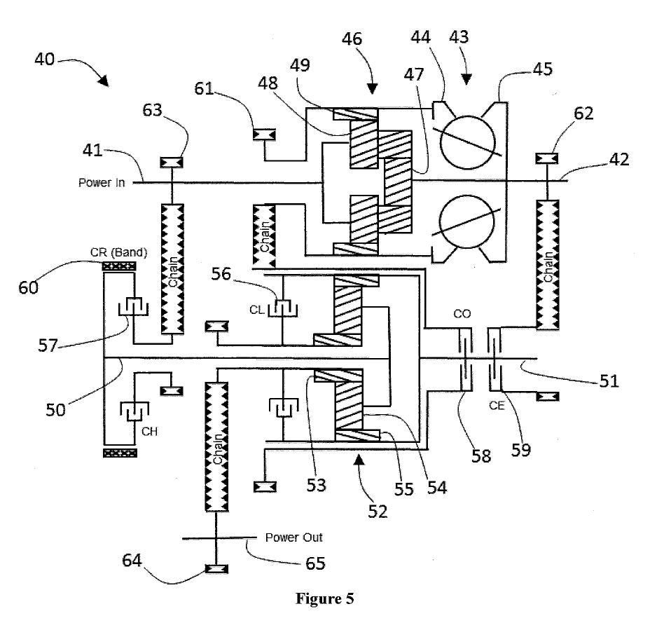

Referring now to FIG. 5, in one embodiment, a continuously variable transmission (CVT) 40 is provided with a first rotatable shaft 41 coaxial with a second rotatable shaft 42. The first rotatable shaft 41 and the second rotatable shaft 42 form a main axis of the CVT 40. The first rotatable shaft 41 is operably coupleable to a source of rotational power. The CVT 40 includes a variator 43 having a first traction ring assembly 44 and a second traction ring assembly 45. For purposes of description and not limitation, the variator 43 is substantially similar to the type of variator depicted in FIGS. 1-3. The variator 43 is coaxial with the main axis of the CVT 40. The second traction ring assembly 45 is coupled to the second rotatable shaft 42. The CVT 40 has a first planetary gear set 46 coaxial with the main axis. The first planetary gear set 46 includes a first sun gear 47, a first planet gear array 48, and a first ring gear 49. In some embodiments, the first planet gear array 48 is configured with well-known stepped gears adapted to couple the first sun gear 47 to the first ring gear 49.

The CVT 40 has a third rotatable shaft 50 arranged substantially parallel to the main axis. The CVT 40 has a fourth rotatable shaft 51 arranged coaxial with to the third rotatable shaft 50. A second planetary gear set 52 is coupled to the third rotatable shaft 50. The second planetary gear set 52 includes a second sun gear 53, a second planet gear array 54, and a second ring gear 55. The CVT 40 is provided with a first clutch 56 arranged coaxially with the third rotatable shaft 50. The first clutch 56 is configured to selectively couple the second ring gear 55 and the second sun gear 53. The CVT 40 is provided with a second clutch 57 arranged coaxially with the third rotatable shaft 50. The CVT 40 is provided with a third clutch 58 and a fourth clutch 59, each arranged coaxially with the fourth rotatable shaft 51.

The CVT 40 includes a reverse band 60 coupled to the second clutch 57. In one embodiment, the reverse band 60 is configured to selectively engage a reverse mode of operation. In one embodiment, the reverse band 60 is a steel band configured to wrap around the second clutch 57. Typically, bands used in transmissions are actuated by hydraulic cylinders inside the case of the transmission. The CVT 40 is provided with a first chain drive 61 adapted to couple the first ring gear 49 to the third clutch 58. The CVT 40 is provided with a second chain drive 62 adapted to couple the second rotatable shaft 42 to the fourth clutch 59.

The CVT 40 is provided with a third chain drive 63 adapted to couple the first rotatable shaft 41 to the second clutch 57. The CVT 40 is provided with a fourth chain drive 64 is operably coupled to a final draft shaft 65. In some embodiments, the final draft shaft 65 is coupled to drive wheels of a vehicle (not shown).

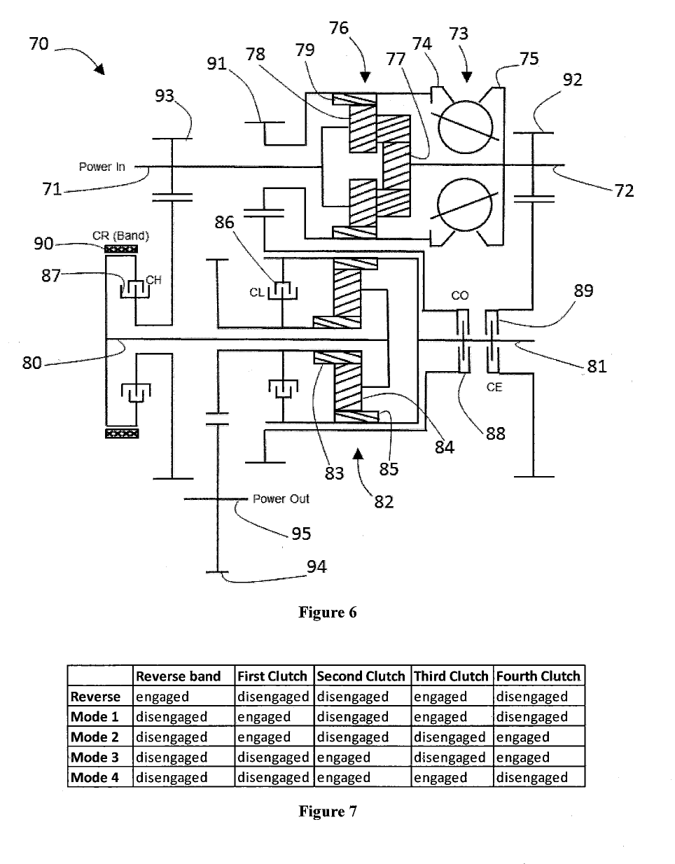

Referring now to FIG. 6, in one embodiment, a continuously variable transmission (CVT) 70 is provided with a first rotatable shaft 71 coaxial with a second rotatable shaft 72. The first rotatable shaft 71 and the second rotatable shaft 72 form a main axis of the CVT 70. The CVT 70 includes a variator 73 having a first traction ring assembly 74 and a second traction ring assembly 75. For purposes of description and not limitation, the variator 73 is substantially similar to the type of variator depicted in FIGS. 1-3. The variator 73 is coaxial with the main axis of the CVT 70. The second traction ring assembly 75 is coupled to the second rotatable shaft 72. The CVT 70 has a first planetary gear set 76 coaxial with the main axis. The first planetary gear set 76 includes a first sun gear 77, a first planet gear array 78, and a first ring gear 79. In some embodiments, the first planet gear array 78 is configured with well-known stepped gears adapted to couple the first sun gear 77 to the first ring gear 79.

The CVT 70 has a third rotatable shaft 80 arranged substantially parallel to the main axis. The CVT 70 has a fourth rotatable shaft 81 arranged coaxial with to the third rotatable shaft 80. A second planetary gear set 82 is coupled to the third rotatable shaft 80. The second planetary gear set 82 includes a second sun gear 83, a second planet gear array 84, and a second ring gear 85. The CVT 70 is provided with a first clutch 86 arranged coaxially with the third rotatable shaft 80. The first clutch 86 is configured to selectively couple the second ring gear 85 and the second sun gear 83. The CVT 70 is provided with a second clutch 87 arranged coaxially with the third rotatable shaft 80. The CVT 70 is provided with a third clutch 88 and a fourth clutch 89, each arranged coaxially with the fourth rotatable shaft 81.

The CVT 70 includes a reverse band 90 coupled to the second clutch 87. In one embodiment, the reverse band 90 is configured to selectively engage a reverse mode of operation. In one embodiment, the reverse band 90 is a steel band configured to wrap around the second clutch 87. Typically, bands used in transmissions are actuated by hydraulic cylinders inside the case of the transmission. The CVT 70 is provided with a first gear set 91 adapted to couple the first ring gear 79 to the third clutch 88. The CVT 70 is provided with a second gear set 92 adapted to couple the second rotatable shaft 72 to the fourth clutch 89. The CVT 70 is provided with a third gear set 93 adapted to couple the first rotatable shaft 71 to the second clutch 87. The CVT 70 is provided with a fourth gear set 94 is operably coupled to a final draft shaft 95. In some embodiments, the final draft shaft 95 is coupled to drive wheels of a vehicle (not shown).

Passing now to FIG. 7, during operation of the CVT 10, the first clutch 26, the second clutch 27, the third clutch 28, the fourth clutch 29, and the reverse band 30 are selectively engaged to provide multiple modes of operation to achieve a desired range of power output through the final drive shaft 38. Likewise, during operation of the CVT 40, the first clutch 56, the second clutch 57, the third clutch 58, and the fourth clutch 59 are selectively engaged to provide multiple modes of operation. For clarity and conciseness, the table depicted in FIG. 7 is applicable to the CVT 10, the CVT 40, and the CVT 70. For example, the column labeled “reverse band” corresponds to the reverse band 30, the reverse band 60, or the reverse band 90; the column labeled “first clutch” corresponds to the first clutch 26, the first clutch 56, or the first clutch 86; the column labeled “second clutch” corresponds to the second clutch 27, the second clutch 57, or the second clutch 87; the column labeled “third clutch” corresponds to the third clutch 28, the third clutch 58, or the third clutch 88; the column labeled “fourth clutch” corresponds to the fourth clutch 29, the fourth clutch 59, or the fourth clutch 89. During operation, a reverse mode is achieved by engagement of the reverse band in coordination with the engagement of the third clutch and disengagement of the first clutch, second clutch, and fourth clutch. A first mode of operation is achieved by engagement of the first clutch and third clutch, and disengagement of the reverse band, the second clutch, and the fourth clutch. A second mode of operation is achieved by engagement of the first clutch and the fourth clutch, and disengagement of the reverse band, the second clutch, and the third clutch. A third mode of operation is achieved by engagement of the second clutch and the fourth clutch, and disengagement of the reverse band, the first clutch, and the third clutch. A fourth mode of operation is achieved by engagement of the second clutch and the third clutch, and disengagement of the reverse band, the first clutch, and the fourth clutch.

As used herein, the terms “mode”, “mode of operation”, or “operating mode” refers to the range of output power and/or output speed or output torque delivered by the CVT for the clutch engagement and disengagement listed in the table if FIG. 7. For example, the first mode of operation corresponds to a range of output speed that is lower than the second mode, etc.

It should be appreciated that the term “clutch” used herein is in reference to any selectable torque transmitting device that includes a wet clutch, a dry clutch, a dog clutch, a synchro clutch, a cone clutch, among others. It should be appreciated that the term “gear set” used herein is in reference to any mating coupling configured to facilitate the transmission of rotatable power.

A continuously variable transmission of any configuration described herein or that would be obvious to one of skill in the art having read the disclosure herein can be included in a vehicle driveline including a power source, wherein the CVT is drivingly engaged with the power source and a vehicle output is drivingly engaged with the CVT.

A method including providing a vehicle including a continuously variable transmission of any configuration described herein or that would be obvious to one of skill in the art having read the disclosure herein.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments described herein may be employed in practicing the disclosure It is intended that the following claims define the scope of the disclosure and that methods and structures within the scope of these claims and their equivalents be covered thereby.

1-22. (canceled)

23. A continuously variable transmission comprising:
a first rotatable shaft operably coupleable to a source of rotational power;
a second rotatable shaft aligned substantially coaxial to the first rotatable shaft, the first rotatable shaft and second rotatable shaft forming a main axis of the transmission;
a third rotatable shaft aligned substantially parallel to the main axis;
a fourth rotatable shaft aligned substantially coaxial to the third rotatable shaft;
a variator assembly having a first traction ring assembly and a second traction ring assembly in contact with a plurality of traction planets, each traction planet having a tiltable axis of rotation, wherein the variator assembly is coaxial with the main axis, the second traction ring assembly is coupled to the second rotatable shaft;
a first planetary gear set having a first sun gear, a first planet gear array, and a first ring gear, wherein the first sun gear is coupled to the second traction ring, the first ring gear is coupled to the first traction ring, and the first planet gear array is operably coupled to the first rotatable shaft;
a second planetary gear set operably coupled to the third rotatable shaft, the second planetary gear set having a second sun gear, a second planet gear array, and a second ring gear, wherein the second ring gear is coupled to the fourth rotatable shaft;
a first clutch positioned coaxial with the third rotatable shaft, the first clutch operably coupled to the second ring gear and the second sun gear;
a second clutch coupled to the third rotatable shaft;
a third clutch coaxial with the fourth rotatable shaft, the third clutch operably coupled to the first ring gear; and
a fourth clutch coaxial with the fourth rotatable shaft, the fourth clutch operably coupled to the second rotatable shaft.

24. The continuously variable transmission of claim 23, further comprising a first gear set coupled to the first ring gear and the third clutch.

25. The continuously variable transmission of claim 24, further comprising a second gear set coupled to the second rotatable shaft and the fourth clutch.

26. The continuously variable transmission of claim 25, further comprising a third gear set coupled to the first rotatable shaft and the second clutch.

27. The continuously variable transmission of claim 23, further comprising a reverse band coupled to the second clutch.

28. The continuously variable transmission of claim 26, further comprising a chain drive coupled to the second sun gear, the chain drive operably coupled to a final gear set.

29. The continuously variable transmission of claim 28, wherein the chain drive comprises a first sprocket and a second sprocket, wherein the first sprocket is operably coupled to the first clutch and the second sprocket is operably coupled to the final gear set.

30. The continuously variable transmission of claim 23, further comprising a first chain drive coupled to the first ring gear and the third clutch.

31. The continuously variable transmission of claim 30, further comprising a second chain drive coupled to the second rotatable shaft and the fourth clutch.

32. The continuously variable transmission of claim 31, further comprising a third chain drive coupled to the first rotatable shaft and the second clutch.

33. The continuously variable transmission of claim 32, further comprising a fourth chain drive coupled to the first clutch and a final drive shaft.

34. The continuously variable transmission of claim 26, further comprising a fourth gear set coupled to the first clutch, the fourth gear set operably coupled to a final drive shaft.

35. The continuously variable transmission of claim 23, wherein the first planet gear array comprises a plurality of stepped gears.

36. The continuously variable transmission of claim 23, wherein the variator comprises a traction fluid.

37. A vehicle driveline comprising: a power source, a continuously variable transmission of claim 23 drivingly engaged with the power source, and a vehicle output drivingly engaged with the continuously variable transmission.

38. The vehicle driveline of claim 37, wherein the power source is drivingly engaged with the vehicle output.

39. The continuously variable transmission of claim 27, wherein the reverse band and the third clutch are engaged to enable a reverse mode.

40. The continuously variable transmission of claim 23, wherein the first clutch and the third clutch are engaged to enable a first mode.

41. The continuously variable transmission of claim 23, wherein the first clutch and the fourth clutch are engaged to enable a second mode.

42. The continuously variable transmission of claim 23, wherein the second clutch and the fourth clutch are engaged to enable a third mode.

43. The continuously variable transmission of claim 23, wherein the second clutch and the third clutch are engaged to enable a fourth mode.
